(19) United States
(12) Patent Application Publication
(10) Pub. No.: US 2007/0288998 A1
(43) Pub. Date: Dec. 13, 2007

(54) System and method for biometric authentication

(76) Inventors: Ganesh Gudigara, Bangalore (IN); Dipak P. Koroth, Sunnyvale, CA (US)

Correspondence Address: FAY KAPLUN & MARCIN, LLP, 15O BROADWAY, SUITE 702, NEW YORK, NY, 10038, US

(21) Appl. No.: 11/439,399

(22) Filed: May 23, 2006

(51) Int. Cl. H04L 9/32

(52) U.S. Cl. 726/5

(57) ABSTRACT

Described is a system and method for biometric authentication. The system comprises a plurality of servers having access to stored biometric data corresponding to a plurality of users, a wireless computing unit receiving biometric data from an imager and a switch communicating with the servers and the unit. The switch receives the biometric data and a service request from the unit. The service request includes service data corresponding to a service provided by at least one of the servers. The switch determines a particular server of the servers to receive the service request as a function of the service data. The switch transmits the biometric data and the service request to the particular server. The particular server performs an authentication procedure as a function of the biometric data and the stored biometric data to generate output data. The particular server executes the service as a function of the service data and the output data.

### FIELD OF INVENTION

The present invention generally relates to systems and methods for biometric authentication.

### BACKGROUND INFORMATION

Authentication systems are often deployed in offices, airports, and other locations where security is desired. Conventional authentication systems include photo identification, access card authentication, and username/password authentication. These authentication systems may be easily compromised through forgery and other methods. Biometric authentication provides a more secure authentication system for overcoming security issues associated with the conventional authentication systems.

Deployment of biometric authentication systems has been limited because of cost and mobility concerns. The introduction of mobile devices has made biometric authentication more portable. However, there exists a need for a system which can take advantage of mobile biometric authentication while being cost-effective.

### SUMMARY OF THE INVENTION

The present invention relates to a system and method for biometric authentication. The system comprises a plurality of servers having access to stored biometric data corresponding to a plurality of users, a wireless computing unit receiving biometric data from an imager and a switch communicating with the servers and the unit. The switch receives the biometric data and a service request from the unit. The service request includes service data corresponding to a service provided by at least one of the servers. The switch determines a particular server of the servers to receive the service request as a function of the service data. The switch transmits the biometric data and the service request to the particular server. The particular server performs an authentication procedure as a function of the biometric data and the stored biometric data to generate output data. The particular server executes the service as a function of the service data and the output data.

### BRIEF DESCRIPTION OF THE DRAWINGS

FIG. 1 is an exemplary embodiment of a system according to the present invention;

FIG. 2 is an exemplary embodiment of a server according to the present invention;

FIG. 3 is an exemplary embodiment of an enrollment method according to the present invention; and

FIG. 4 is an exemplary embodiment of a service request/fulfillment method according to the present invention.

### DETAILED DESCRIPTION

The present invention may be further understood with reference to the following description and the appended drawings, wherein like elements are provided with the same reference numerals. The present invention provides a system and a method for biometric authentication. More specifically, the present invention provides a system and a method for biometric authentication in a wireless environment.

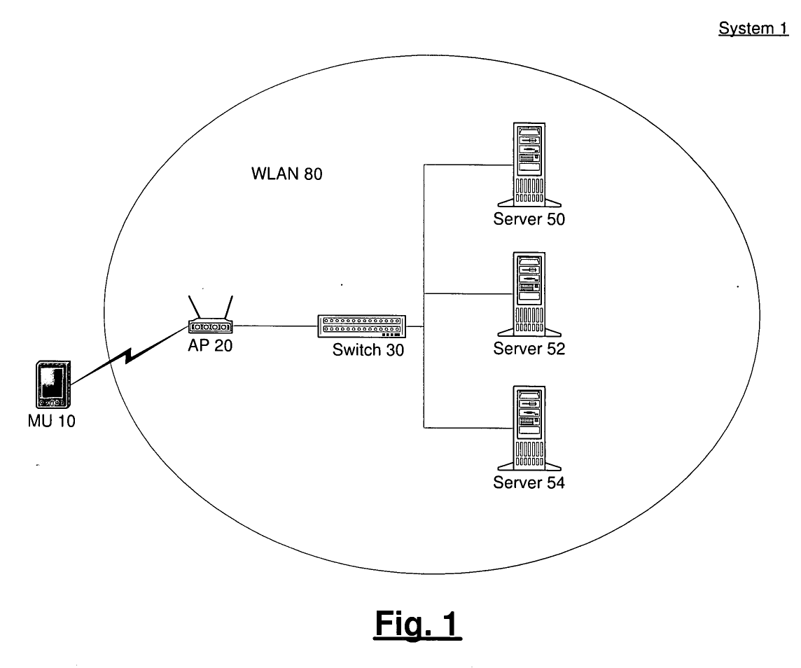

FIG. 1 shows an exemplary embodiment of a system 1 according to the present invention. The system 1 includes one or more servers 50, 52, 54 (e.g., Remote Authentication Dial In User Service (“RADIUS”) servers) storing data and fulfilling data/service requests for devices in the system 1. A network management arrangement (e.g., a switch 30) coupled to the servers 50-54 enables communication between the servers 50-54 and a wireless computing device (e.g., a mobile unit (“MU”) 10). For example, the MU 10 transmits a wireless signal to an access point/port (“AP”) 20 which forwards the signal to the switch 30. The switch 30 determines which of the servers 50-54 the signal is addressed to and forwards the signal to the selected server. The MU 10 may communicate with the AP 20 and/or the switch 30 according to a predetermined wireless communications protocol (e.g., 802.11x, 802.16, etc.).

The MU 10 may be any wireless computing device (e.g., a laptop, a PDA, a mobile phone, a laser-/imager-based scanner, an RFID reader, a network interface card, etc.) capable of wireless communication. The MU 10 may include or be coupled to an imager (e.g., a biometric scanner, a fingerprint scanner, an iris scanner, a voice recognition module, etc.). For example, the imager may be the SecuGen® Hamster III, available from SecuGen Corp., coupled to the MU 10 via a hardware arrangement (e.g., serial, USB, infrared, etc.). Depending on a desired functionality, the MU 10 may be wall-mounted or otherwise secured to a fixed location, or may be untethered. For example, the MU 10 may be mounted adjacent a locked door requiring biometric authentication to unlock the door. In another example, the imager may be coupled to a laptop which is capable of accessing a wireless computing network (e.g., a WLAN 80) when the user's biometric data is authenticated.

When conducting wireless communications, the MU 10 may utilize an authentication mechanism, such as, for example, an Extensible Authentication Protocol (“EAP”), in which the MU 10 transmits and receives data which has been encrypted using one of any number of standard encryption techniques (e.g., Wired Equivalent Privacy (“WEP”), Wifi-Protected Access (“WPA”), Temporal Key Integrity Protocol (“TKIP”), etc.).

In one exemplary embodiment, each server 50-54 provides a dedicated service, such as an authentication service, a time/attendance service or a network access service. In another exemplary embodiment, each server 50-54 provides each (or selected ones) of the services. The switch 30 collects service data from each server indicative of the service(s) provided thereby. For example, the server 50 may provide the authentication service for authorizing access to physical locations, authenticating participants in a teleconference, etc. The switch 30 may communicate with the servers 50-54 through use of a software module, such as a RADIUS relay agent, which uses a server communication protocol (e.g., a RADIUS protocol). In addition, a system administrator may configure the servers 50-54 (e.g., changing IP addresses, adding/removing services) using an interface (e.g., a command line interface) provided by the switch 30. The switch 30 may periodically poll the servers 50-54 in order to identify the supported services and report those services to the MU 10. If there is a change in the supported services, the switch 30 may communicate the change to the MU 10.

During operation, the user may encounter the MU 10 when arriving at a workstation (e.g., a cubicle) and beginning a shift at work. The user may be required to report a time of arrival at the workstation. The MU 10 may provide a display which indicates a time/attendance service and a network access service. When the time/attendance service is selected, the MU 10 prompts the user to input a user identifier/password and/or a biometric (e.g., fingerprint, iris). The MU 10 generates and transmits biometric data in a wireless signal to the switch 30 via the AP 20 according to a predetermined wireless communication protocol (e.g., IEEE 802.1x).

Upon receipt of the signal, the switch 30 determines the server to transmit the signal to as a function of the service requested. For example, because the time/attendance service was requested, the switch 30 transmits the signal to the corresponding server (e.g., server 50). The transmission to the server 50 may require the switch 30 to convert the signal to the server communication protocol (e.g., the RADIUS protocol). When the server 50 receives the signal, it may perform a database lookup using the user identifier and the biometric data. If the biometric data is authorized (e.g., included in the database), the server 50 performs the requested service, which in this example is the time/attendance service. Thus, the server 50 may enter the user's identifier and a timestamp on an attendance log. A confirmation signal may be transmitted by the server 50 to the MU 10 confirming that the service was performed.

Those of skill in the art will understand that when the user is authenticated, the corresponding server performs the requested service. For example, when network access is requested and the biometric data is validated, the user may be logged onto a secure network. Thus, the system 1 may be utilized for record-keeping, personnel monitoring, securing physical locations, computing networks, databases, etc.

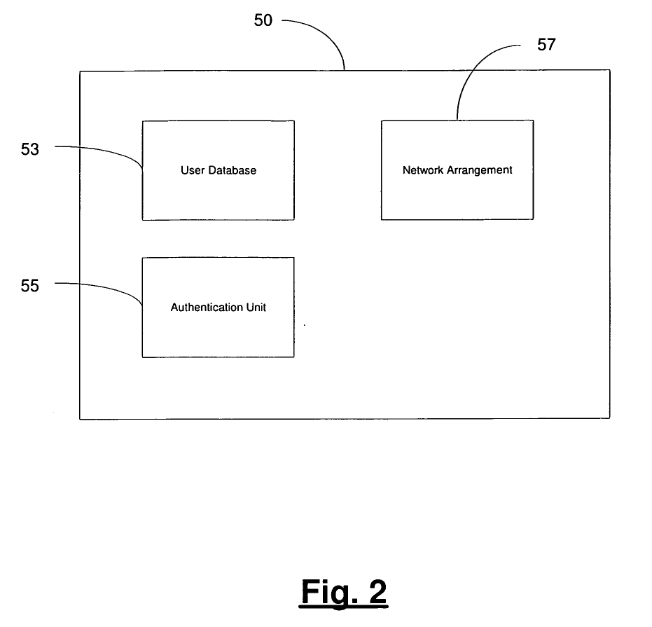

FIG. 2 shows an exemplary embodiment of a server (e.g., the server 50) according to the present invention. The server 50 may include a user database 53, an authentication unit 55, and a network arrangement 57. The user database 53 may include authentication data utilized in an authentication procedure. For example, the authentication data may include one or more user identifiers/passwords and corresponding biometric data. The authentication unit 55 may include hardware, software, or a combination thereof, which enables the server 50 to authenticate a user of the MU 10. The network arrangement 57 may include a hardware arrangement (e.g., USB, Firewire, Ethernet, etc.) for coupling the server 50 to one or more switches 30 enabling communication therewith. The servers 52, 54 may be substantially similar to the server 50.

At least one of the servers 50-54 may be responsible for managing the WLAN 80 including, for example, granting access to MUs attempting to access the WLAN 80 and providing services to the MUs. Those skilled in the art will understand that the present invention may not be limited to WLANs, but may also be successfully implemented in any wireless network, such as, for example, a wireless wide area network (“WWAN”).

According to the present invention, the system 1 may be operated in an enrollment mode and/or an identification/verification mode. In the enrollment mode, a new user may be added to the user database 53, or a database entry corresponding to an existing user may be modified. In the identification/verification mode, the user requests access to a service (e.g., the time/attendance, authorization, network access, etc.) by submitting a service request to the switch 30 via the MU 10.

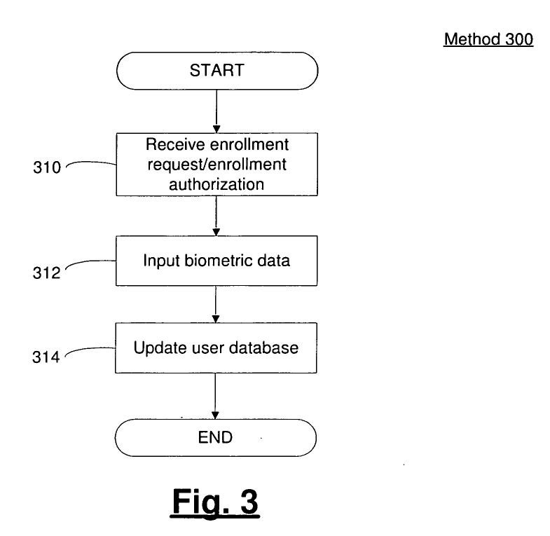

FIG. 3 shows an exemplary embodiment of a method 300 for enrolling a user in the system 1 according to the present invention. In step 310, the switch 30 receives an enrollment request from the MU 10. The enrollment request may include the user identifier (e.g., a bar code) and/or the user password (e.g., a PIN). The enrollment request may further include the biometric data for enrolling the user or updating the user database 53.

In step 312, the user inputs the biometric by, for example, placing a finger against the imager. The imager may then read an image of the user's finger and compress the image generating the biometric data. The biometric data may then be encrypted using the standard encryption technique (e.g., WEP, WPA, etc.) prior to being wirelessly transmitted to the server 50 via the AP 20 and the switch 30. When the switch 30 receives the enrollment request, it determines which of the servers 50-54 should receive the request as a function of the services provided thereby. For example, the server 50 may handle the enrollment requests. Furthermore, the switch 30 may reformat the enrollment request into a signal compatible with the server communication protocol prior to transmission to the server 50. In step 314, the server 50 enrolls the user and/or updates the user database 53 by storing the biometric data and/or the user identifier/password.

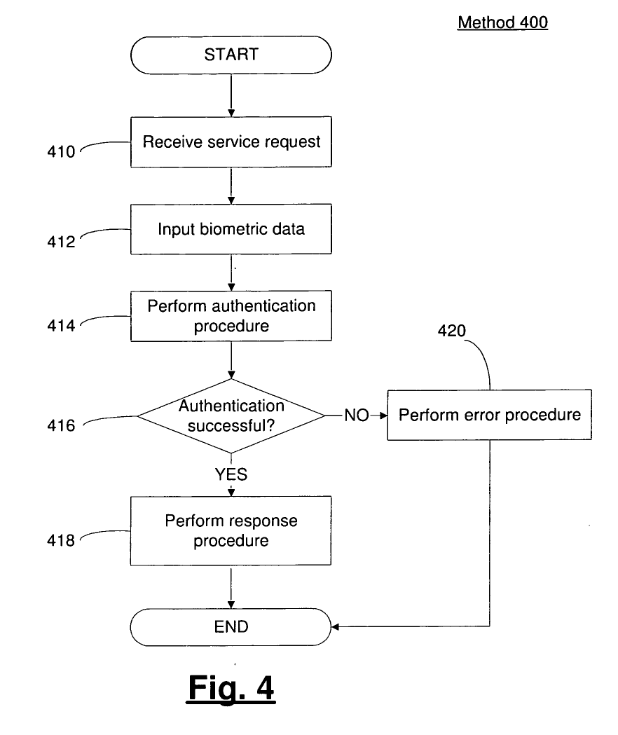

FIG. 4 shows an exemplary embodiment of a method 400 for responding to a service request according to the present invention. In step 410, the switch 30 receives the service request from the MU 10. The switch 30 may then transmit the service request to the server 50 after selecting the appropriate server as a function of the service requested. The server 50 may issue a response (e.g., an access challenge) to the MU 10 requiring the user to submit authenticating information (e.g., biometric data) prior to fulfilling the service request. In another exemplary embodiment, the service request includes the biometric data and the method proceeds to step 414.

In step 412, the user inputs the biometric data in response to the access challenge. For example, the user may place a finger against the imager which generates the biometric data by obtaining an image of the user's finger. The image may be compressed, and optionally encrypted using the standard encryption technique. The compression and encryption may be executed at the MU 10 or the switch 30.

In step 414, the server 50 performs an authentication procedure, which may include comparing the biometric data against stored biometric data in the user database 53 to determine whether the biometric data matches the stored biometric data which was stored during enrollment.

In step 416, the server 50 determines whether the authentication procedure was successful. If a match is found in the user database 53, the user's identity is verified and the authentication procedure succeeds. However, if the match was not found, then the authentication procedure fails.

In step 418, the authentication procedure was successful, and the server 50 performs the response procedure (e.g., fulfilling the service request). The response procedure may include a response signal (e.g., an access accept) transmitted to the MU 10 which notifies the user that the service request was successful. For example, if the desired service is the time/attendance, the server 50 may update the user database 53 to indicate a time and/or a location at which the biometric data was received, thereby establishing the user's presence. If the desired service is the authentication/authorization, the server 50 may determine whether the user is authorized for a particular action (e.g., accessing a restricted area), and allow the user access to the restricted area by opening a locked door, transmitting an encoded key to the MU 10 which unlocks a door, etc. And if the desired service is the system resource, the server 50 may allow the user access to the WLAN 80.

In step 420, the authentication procedure was not successful and the server 50 performs an error procedure, which may include a response (e.g., an access reject) indicating that the user was unable to be authenticated. The error procedure may also include an alert to the system administrator.

Those skilled in the art will understand that the present invention provides a secure authentication method which is difficult to bypass. In addition, the present invention provides a system which is cost-effective. By utilizing existing network infrastructures, the present invention may be deployed on any wireless network, enabling authentication to be performed without costly equipment upgrades. Furthermore, the present invention provides a cost-effective and secure means for monitoring users which ensures that the user is actually present when an authentication is performed.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a plurality of servers having access to stored biometric data corresponding to a plurality of users;
a wireless computing unit receiving biometric data from an imager; and
a switch communicating with the servers and the unit, the switch receiving the biometric data and a service request from the unit, the service request including service data corresponding to a service provided by at least one of the servers, the switch determining a particular server of the servers to receive the service request as a function of the service data, the switch transmitting the biometric data and the service request to the particular server,
wherein the particular server performs an authentication procedure as a function of the biometric data and the stored biometric data to generate output data, the particular server executing the service as a function of the service data and the output data.

2. The system according to claim 1, wherein the servers are remote authentication dial in user service (RADIUS) servers.

3. The system according to claim 1, wherein the unit is one of a laser-based scanner, an imager-based scanner, an RFID reader, a mobile phone, a PDA, a laptop and a network interface card.

4. The system according to claim 1, wherein the biometric data is at least one of a fingerprint scan, an iris scan and a voice sample.

5. The system according to claim 1, wherein the imager is integral with the unit.

6. The system according to claim 1, wherein the unit encrypts the biometric data using one of (i) an Extensible Authentication Protocol, (ii) a Wired Equivalency Protocol, (iii) a Wifi-Protected Access mechanism and (iv) a Temporal Key Integrity Protocol.

7. The system according to claim 2, wherein the switch receives the biometric data and the service request in a first signal in a form of a wireless communication protocol and converts the first signal to a second signal in a form of a RADIUS protocol.

8. The system according to claim 1, wherein the service is one of a time/attendance service, an authentication service, a network access service, an enrollment service and a teleconferencing service.

9. The system according to claim 1, wherein the authentication procedure is a comparison of the biometric data and the stored biometric data.

10. The system according to claim 1, wherein the output data further reflects a service access level associated with the stored biometric data.

11. A method, comprising:
receiving, by a wireless computing unit, biometric data from an imager;
receiving, by a switch, the biometric data and a service request from the unit, the service request including service data corresponding to a service provided by at least one of a plurality of servers, the servers having access to stored biometric data corresponding to a plurality of users;
determining, by the switch, a particular server of the servers to receive the service request as a function of the service data;
transmitting the biometric data and the service request to the particular server by the switch;
performing an authentication procedure, by the particular server, as a function of the biometric data and the stored biometric data to generate output data; and
executing the service, by the particular server, as a function of the service data and the output data.

12. The method according to claim 11, wherein the servers are remote authentication dial in user service (RADIUS) servers.

13. The method according to claim 11, wherein the unit is one of a laser-based scanner, an imager-based scanner, an RFID reader, a mobile phone, a PDA, a laptop and a network interface card.

14. The method according to claim 11, wherein the biometric data is at least one of a fingerprint scan, an iris scan and a voice sample.

15. The method according to claim 11, further comprising:
encrypting the biometric data using one of (i) an Extensible Authentication Protocol, (ii) a Wired Equivalency Protocol, (iii) a Wifi-Protected Access mechanism and (iv) a Temporal Key Integrity Protocol.

16. The method according to claim 12, further comprising:
receiving, by the switch, the biometric data and the service request in a first signal in a form of a wireless communication protocol; and
converting the first signal to a second signal in a form of a RADIUS protocol.

17. A device, comprising:
a communications arrangement receiving biometric data and a service request from a wireless computing unit, the service request including service data corresponding to a service provided by at least one of a plurality of servers; and
a processor determining a particular server of the servers to receive the service request as a function of the service data, the processor transmitting the biometric data and the service request to the particular server for authentication of the biometric data.

18. The device according to claim 17, wherein the servers have access to stored biometric data corresponding to a plurality of users.

19. The device according to claim 18, wherein the particular server performs an authentication procedure as a function of the biometric data and the stored biometric data to generate output data.

20. The device according to claim 19, wherein the particular server executes the service as a function of the service data and the output data.

21. A device, comprising:
a communications means for receiving biometric data and a service request from a wireless computing unit, the service request including service data corresponding to a service provided by at least one of a plurality of servers; and
a processing means for determining a particular server of the servers to receive the service request as a function of the service data, the processor transmitting the biometric data and the service request to the particular server for authentication of the biometric data.
